(19) United States
(12) Patent Application Publication
(10) Pub. No.: US 2018/0373951 A1
(43) Pub. Date: Dec. 27, 2018

(54) IMAGE PROCESSING APPARATUS, IMAGE PROCESSING METHOD, AND STORAGE MEDIUM

(71) Applicant: CANON KABUSHIKI KAISHA, Tokyo (JP)

(72) Inventors: Hidenori Ito, Kunitachi-shi (JP); Kiwamu Kobayashi, Kawasaki-shi (JP)

(21) Appl. No.: 16/006,149

(22) Filed: Jun. 12, 2018

(30) Foreign Application Priority Data
Jun. 23, 2017 (JP) 2017-123409

(51) Int. Cl. G06K 9/32; G06T 3/00; H04N 7/01

(52) U.S. Cl. CPC G06K 9/3233; H04N 7/01; G06T 3/00

(57) ABSTRACT

The image processing apparatus includes: a format conversion unit configured to convert an image in a first format into an image in a second format whose amount of information indicating image quality characteristics is reduced compared to that of the image in the first format; a detection unit configured to detect a partial region in the image in the second format; an inverse conversion unit configured to inversely convert region information representing the detected partial region into region information corresponding to the first format; and an extraction unit configured to extract a partial image in the first format by using the inversely converted region information.

### BACKGROUND OF THE INVENTION

### Field of the Invention

The present invention relates to an image processing technique and in more detail, to a technique to extract a region of interest of a captured image.

### Description of the Related Art

As the format of a captured image captured by a camera, a format is adopted, which has only pixel information on one channel in one pixel. In many cases, the format of a captured image is not convenient in performing high-level image processing, such as geometric transformation and image recognition, unless some processing is performed for the format, and therefore, a method of converting the format of a captured image into a format having pixel information on a plurality of channels at one pixel position is performed widely. As the format having pixel information on a plurality of channels at one pixel position, for example, the RGB format and the YCbCr format exist.

Generally, in such format conversion, there is a possibility that the image quality of an image after format conversion is reduced because demosaicking processing is performed for the captured image. In order to restore the image quality reduced by format conversion, the method of Japanese Patent Laid-Open No. 2011-066748 has been proposed. Japanese Patent Laid-Open No. 2011-066748 has disclosed a resolution conversion technique to reproduce an edge (boundary where light and shade are clear) included in a RAW image in an RGB 3 channel image by performing resolution conversion of the RGB 3 channel image by using edge information obtained from the RAW image.

### SUMMARY OF THE INVENTION

The present invention provides a technique that obtains an image from which information indicating image quality characteristics of a captured image is not lost while reducing the amount of data.

The image processing apparatus of the present invention has: a format conversion unit configured to convert an image in a first format into an image in a second format whose amount of information indicating image quality characteristics is reduced compared to that of the image in the first format; a detection unit configured to detect a partial region in the image in the second format; an inverse conversion unit configured to inversely convert region information representing the detected partial region into region information corresponding to the first format; and an extraction unit configured to extract a partial image in the first format by using the inversely converted region information.

Further features of the present invention will become apparent from the following description of exemplary embodiments with reference to the attached drawings.

### BRIEF DESCRIPTION OF THE DRAWINGS

FIG. 1 is a hardware configuration example of an image processing apparatus in a first embodiment;

FIG. 2 is a block diagram showing a function configuration example of the image processing apparatus in the first embodiment;

FIG. 3 is a flowchart showing a generation procedure example of a RAW partial image in the first embodiment;

FIGS. 4A and 4B are diagrams showing an example of a RAW image and an example of an RGB image in the first embodiment;

FIGS. 5A and 5B are diagrams showing examples of a foreground region in the first embodiment;

FIGS. 6A and 6B are diagrams showing an example of a Bayer array foreground region and an example of a RAW partial image region in the first embodiment;

FIGS. 7A and 7B are diagrams explaining the Bayer array foreground region and the RAW partial image region in the first embodiment;

FIG. 8 is a diagram showing an example of the RAW partial image in the first embodiment:

FIG. 9 is a block diagram showing a function configuration example of an image processing apparatus in a second embodiment;

FIG. 10 is a flowchart showing a generation procedure example of a RAW partial image in the second embodiment; and

FIGS. 11A to 11F are diagrams showing specific examples in which the RAW partial image is generated from a RAW image in the second embodiment.

### DESCRIPTION OF THE EMBODIMENTS

In an image processing system having a configuration in which a captured image is transmitted to an image processing server, in view of image processing performed in the image processing server, it is preferable for information indicating image quality characteristics of the captured image to be transferred to the image processing server with as slight a loss as possible of the information.

However, in a case where an image whose amount of data is large (for example, RAW image) is transferred to the image processing server, the processing load of the entire image processing system increases. Although a method of transferring an RGB 3 channel image generated by the method of Japanese Patent Laid-Open No. 2011-066748 to the image processing server is considered, it is difficult to completely restore an edge included in a RAW image and information indicating image quality characteristics other than the edge is lost.

In the following, embodiments for embodying the present invention are explained with reference to the drawings. Note that the configurations described in the embodiments are merely exemplary and are not intended to limit the scope of the present thereto.

### First Embodiment

### (Hardware Configuration Example of Image Processing Apparatus)

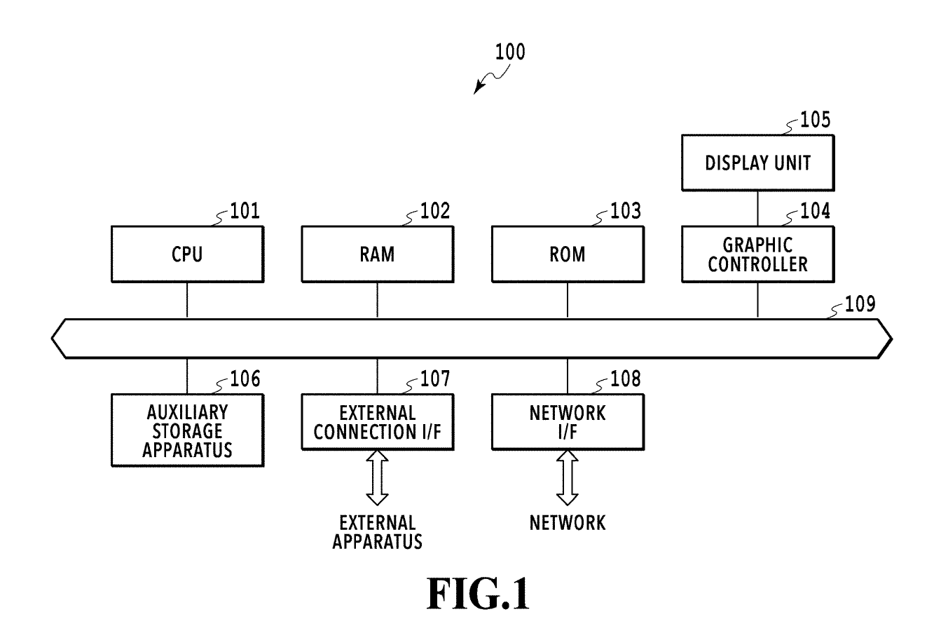

FIG. 1 is a block diagram showing a hardware configuration example of an image processing apparatus 100 in the present embodiment. The image processing apparatus 100 includes a CPU 101, a RAM 102, a ROM 103, a graphic controller 104, a display unit 105, and an auxiliary storage apparatus 106. Further, the image processing apparatus 100 includes an external connection interface 107 (hereinafter, interface is described as “I/F”) and a network I/F 108 and each constituent unit is connected via a bus 109 so as to be capable of communication. The CPU 101 includes an operation circuit and centralizedly controls the image processing apparatus 100. The CPU 101 reads programs stored in the ROM 103 or the auxiliary storage apparatus 106 onto the RAM 102 and performs various kinds of processing. The ROM 103 stores system software and the like, such as a BIOS, used to control the image processing apparatus 100. The graphic controller 104 generates a screen that is displayed on the display unit 105. The display unit 105 includes an LCD (Liquid Crystal Display) and the like and displays a screen generated by the graphic controller 104. Further, the display unit 105 may have a touch screen function. In such a case, it is also be possible to handle user instructions whose input is received via the display unit 105 as an input to the image processing apparatus 100. The auxiliary storage apparatus 106 has a function as a storage region and stores an OS (Operating System), device drivers for controlling various devices, application programs performing various kinds of processing, and so on. The auxiliary storage apparatus 106 is an example of the storage apparatus and can be made up of an SSD (Solid State Drive) and the like, in addition to an HDD (Hard Disk Drive). The external connection I/F 107 is an interface for connecting various devices to the image processing apparatus 100. For example, it is possible to connect input/output apparatuses, such as a keyboard and a mouse, via the external connection I/F 107. The network I/F 108 performs communication with an external device via a network based on control of the CPU 101. In the present embodiment, the example in which the image processing apparatus 100 is an information processing apparatus (so-called PC and the like) as shown in FIG. 1 is explained, but the hardware configuration is not limited to the information processing apparatus such as this. The image processing apparatus 100 may be implemented by, for example, an ASIC, an electronic circuit, and so on. In this case, these ASIC and electronic circuit may be incorporated in a camera, not shown schematically.

### (Generation Procedure Example of RAW Partial Image)

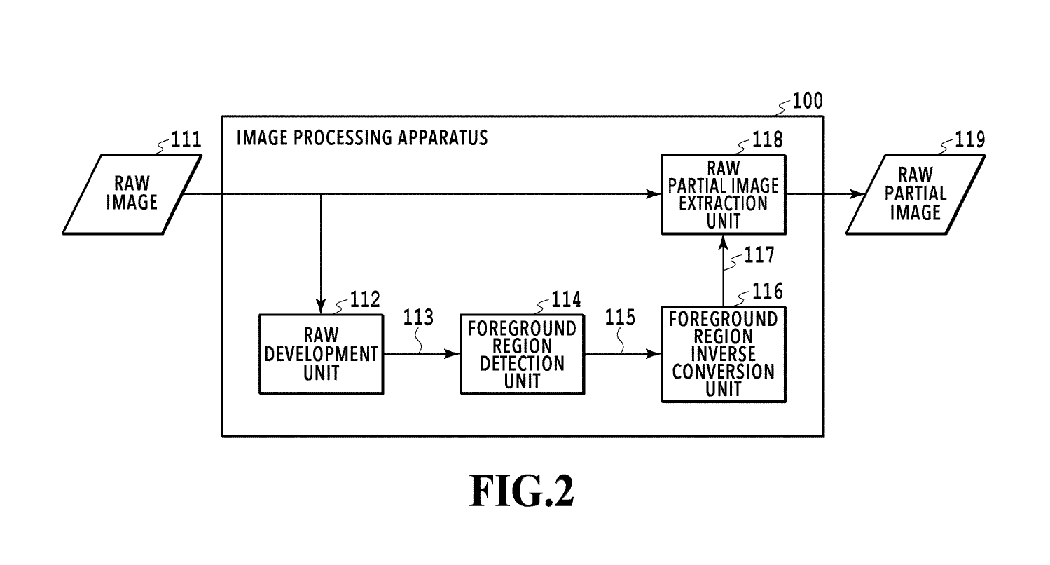

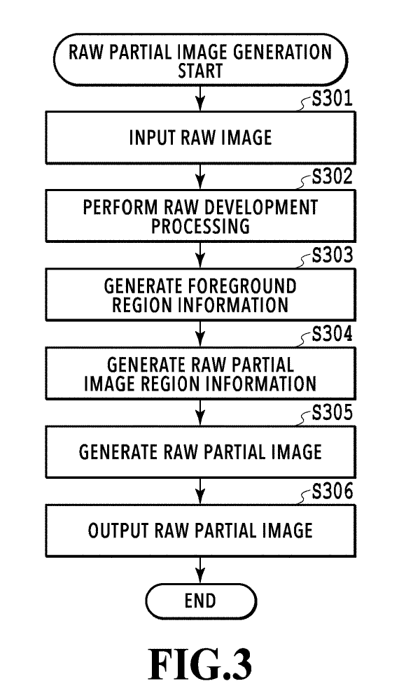

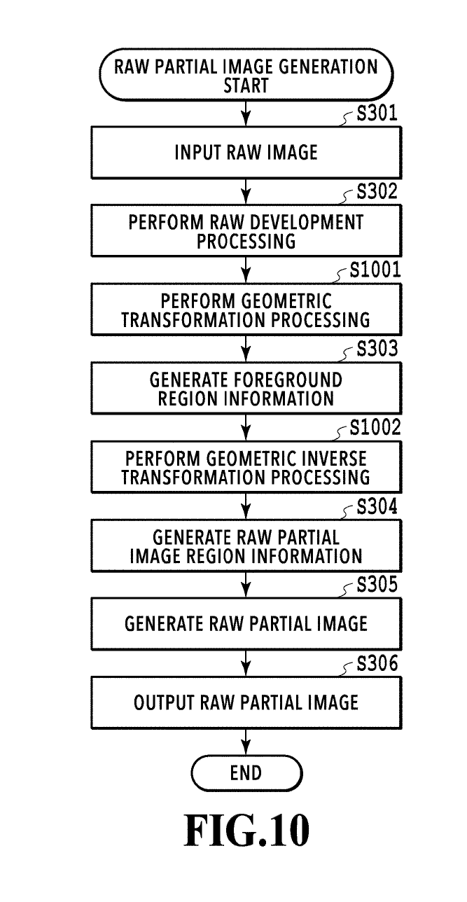

FIG. 2 is a block diagram showing a function configuration example of the image processing apparatus 100 in the present embodiment. FIG. 3 is a flowchart showing a generation procedure example of a RAW partial image 119 in the present embodiment. The image processing apparatus 100 receives an input of a RAW image 111 captured by a camera, not shown schematically, and outputs the RAW partial image 119, which is an image obtained by cutting out only the portion of a region of interest in the captured RAW image 111. In the following, with reference to FIG. 2 to FIG. 8, a processing procedure performed by the image processing apparatus 100 in the present embodiment is explained. The processing of the flowchart shown in FIG. 3 is performed by the CPU 101 loading program codes stored in the storage region, such as the ROM 103, onto the RAM 102 and executing the program codes. Each symbol S below means that the step is a step in the flowchart. This is also the same with a flowchart in FIG. 10.

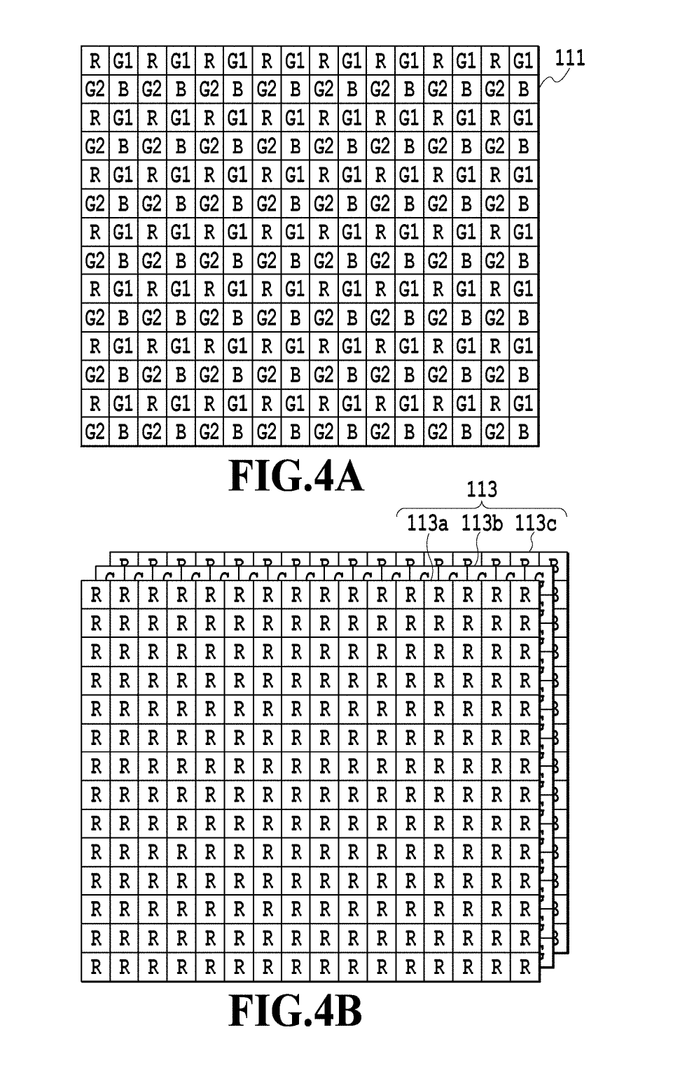

At step S301, the RAW image 111 is input. The RAW image 111 is a camera-captured image input to the image processing apparatus 100 from a camera, not shown schematically. It is assumed that the RAW image 111 of the present embodiment is image data whose each pixel is in the Bayer array, but the embodiment is not applied only to image data of the Bayer array. The RAW image 111 is an image in a RAW image format having, for example, a pixel array of one channel as shown in FIG. 4A.

At S302, a RAW development unit 112 performs RAW development processing. That is, the RAW development unit 112 converts the format of image data from that of the RAW image 111 of the Bayer array into that of an RGB image 113. The RGB image 113 in FIG. 4B is an example of the results of performing RAW development processing for the RAW image 111 in FIG. 4A. The RGB image 113 is an image in an image format having pixel values of three channels of R, G, and B for each pixel. As the array of pixel values of each channel, an R channel image 113a, a G channel image 113b, and a B channel image 113c are shown.

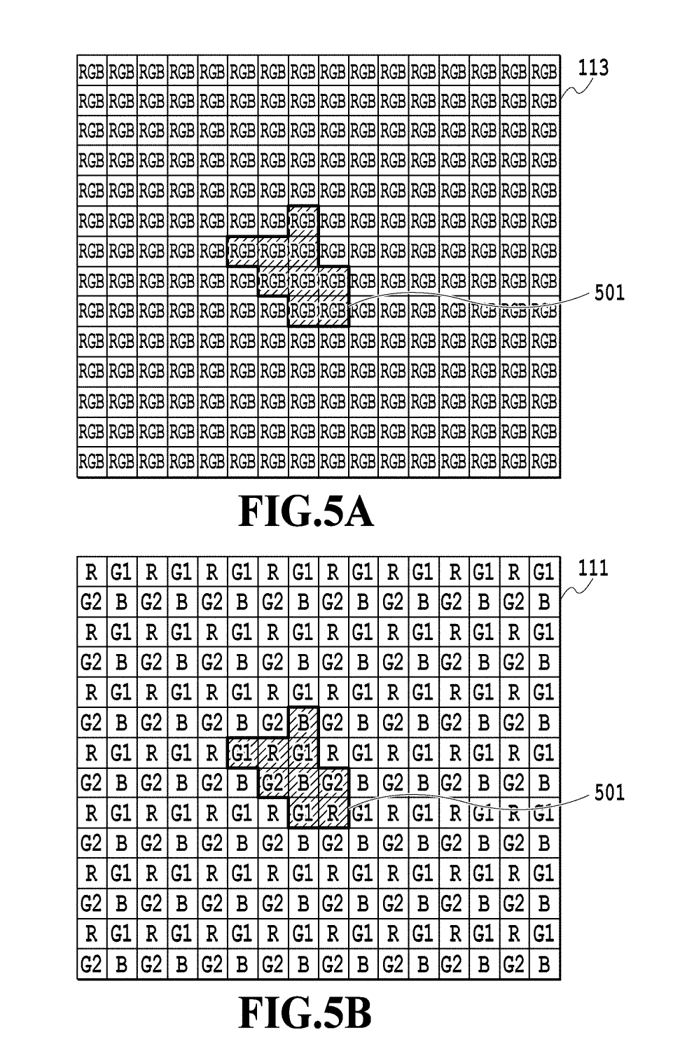

At S303, a foreground region detection unit 114 receives an input of the RGB image 113, detects a foreground region within the image, and generates foreground region information 115. An example of a foreground region 501 within the RGB image 113 indicated by the foreground region information 115 is shown in FIG. 5A. Here, the foreground region is, for example, a region or the like where a camera is capturing a playing player in a case where the camera is capturing sports, and a region or the like where a monitoring camera is capturing a monitoring target existing within the image capturing range in a case where the monitoring camera is performing image capturing. That is, it can be said that the foreground region information 115 of the present embodiment is a mask image that detects a pixel, a target to be extracted from the RGB image 113. There are various methods as the extraction method of a foreground region. For example, there is a method of extracting a foreground region from a difference between a background image, which is generated by performing somewhat long-time image capturing of a predetermined image capturing range, and a captured image at a certain instant. The foreground region detection method in the present embodiment is not limited to a specific method. As shown in FIG. 5A, the foreground region information 115 is information indicating a partial region in the RGB image 113 and is sectioned in units of pixels.

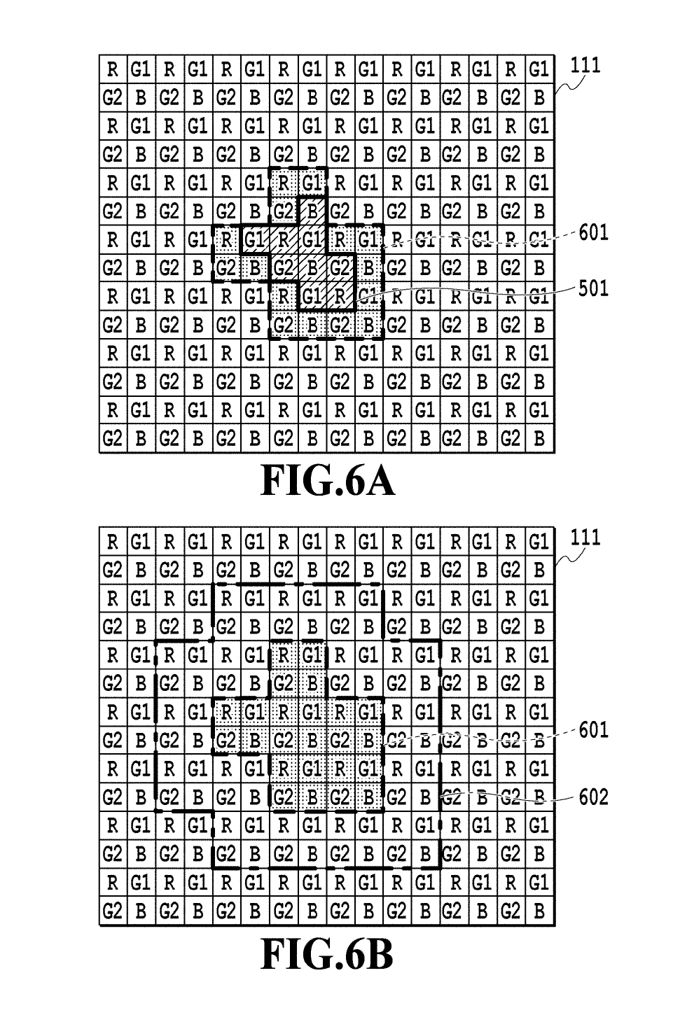

At S304, a foreground region inverse conversion unit 116 receives an input of the foreground region information 115 and calculates to which position of the original RAW image 111 the input foreground region corresponds. Then, the foreground region inverse conversion unit 116 generates RAW partial image region information 117 based on the corresponding portion of the foreground region in the original RAW image 111. In the following, the above-described processing performed by the foreground region inverse conversion unit 116 is explained with reference to FIG. 5B, FIG. 6A, and FIG. 6B.

FIG. 5B is a diagram showing a region corresponding to the foreground region 501 indicated by the foreground region information in the RAW image 111. In the present embodiment, a case is supposed where the number of pixels of the RAW image 111 and the number of pixels of the RGB image 113 are the same. Because of this, it is possible to take the position of the foreground region 501 indicated by the foreground region information to be the corresponding position in the RAW image 111 as it is.

The image processing apparatus 100 of the present embodiment aims at extracting the region of interest in the RAW image 111 as the RAW partial image 119. For example, a case is considered where the RAW partial image 119 is transmitted to an image processing server (not shown schematically) in an image processing system with a configuration in which a captured image captured by a camera is transmitted to the image processing server. In this case, in view of image processing in a subsequent stage performed by the image processing server, it is desirable for the RAW partial image 119 to be pulled out in units of sets, the set including the kinds of pixels of four channels of R, G1, G2, and B making up the Bayer array. Hereinafter, the set of R, G1, G2, and B pixels in a RAW image is described as “Bayer unit”. In the present embodiment, a method is applied, which extracts a partial image by taking the Bayer unit as the minimum unit. However, the method of extracting a partial image is not limited to the above-described method and it is not necessarily required to extract a partial image in Bayer units.

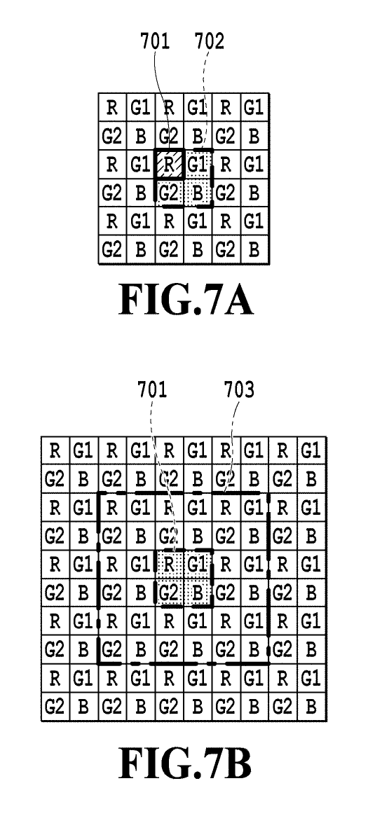

FIG. 6A shows a Bayer array foreground region 601 obtained by extending the foreground region 501 indicated by the foreground region information to the Bayer unit. Further, FIG. 6B shows an example in which the Bayer units adjacent to the Bayer array foreground region 601 in FIG. 6A in a total of eight directions, that is, vertical, horizontal, and diagonal directions are taken to be a RAW partial image region 602. Here, with reference to FIGS. 7A and 7B, a method of generating, based on foreground region information in an RGB image, Bayer array foreground information indicating a region corresponding to the above-described foreground region in a RAW image is explained in more detail. FIG. 7A shows a Bayer array foreground region 702 in a case where an R pixel 701 of a RAW image is specified as a foreground region. As shown in FIG. 7A, in the present embodiment, in a case where one pixel in the Bayer unit is specified as a foreground region, the Bayer unit is taken to be a Bayer array foreground region. This is also the same in a case where a pixel other than the R pixel in the RAW image is specified as a foreground region.

FIG. 7B is a diagram showing a RAW partial image region 703 generated by extending the Bayer array foreground region. Here, a method of generating RAW partial image region information from the Bayer unit specified as a Bayer array foreground region is explained. In the example in FIG. 7B, an example is shown in which the Bayer units adjacent to the Bayer unit in the Bayer array foreground region 702 in a total of eight directions, that is, vertical, horizontal, and diagonal directions are taken to be the RAW partial image region 703. In the processing to generate the RAW partial image region information 117, to which extent the surrounding Bayer units are included in the RAW partial image region is determined by how many RAW pixels are referred to in order to generate certain RGB pixels in the RAW development processing. The reason is to make it possible for an image processing server (not shown schematically) arranged in a subsequent stage of the image processing apparatus 100 of the present embodiment to perform RAW development processing by using only a RAW partial image in a case of obtaining the RAW partial image. At this time, the surrounding area that is referred to in the RAW development processing performed in a subsequent stage is not necessarily the same as the surrounding area that is referred to in the RAW development processing performed in the image processing apparatus 100 (RAW development unit 112). For example, in a case where it is desired to perform the RAW development processing performed in a subsequent stage in more detail in order to check the region of interest by an image with a higher accuracy, more surrounding areas are referred to in the RAW development processing performed in a subsequent stage. In such a case, the foreground region inverse conversion unit 116 calculates RAW partial image region information by taking into consideration processing of the entire image processing system including processing performed in subsequent stages in place of taking into consideration only the RAW development processing performed within the image processing apparatus 100.

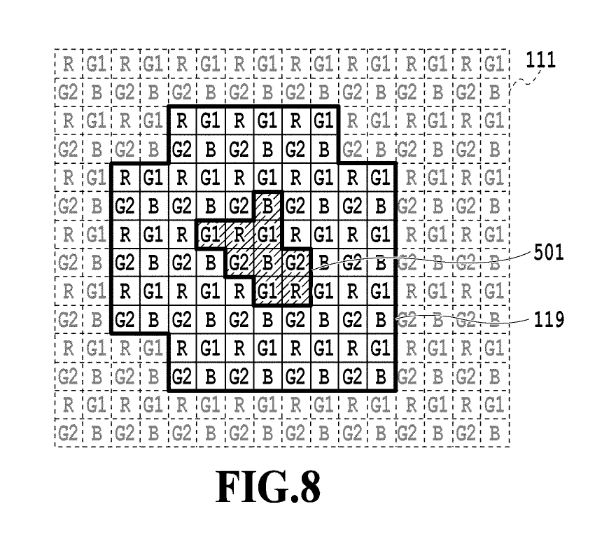

At S305, a RAW partial image extraction unit 118 generates the RAW partial image 119 based on the RAW image 111 input to the image processing apparatus 100 and the RAW partial image region information 117. Next, at S306, the generated RAW partial image 119 is output. FIG. 8 shows an example of the RAW partial image 119 extracted from the RAW image 111. The RAW partial image 119 shown in FIG. 8 is extracted by using the RAW image 111 and the RAW partial image region information 117. In FIG. 8, the portion described by the solid line indicates the extracted image region and the portion described in gray-out indicates the image region not extracted. In FIG. 8, the RAW partial image 119 is shown schematically by being superimposed by the foreground region 501. It is known that the RAW partial image 119 is obtained by the region indicated by the foreground region 501 is extended by the surrounding area. As described above, by extracting the RAW partial image 119 obtained by extending the surroundings of the region of interest, even in a case where the RAW image is processed in image processing in a subsequent stage, it is possible to suppress degradation in image quality in the RAW development processing.

As explained above, the image processing apparatus of the present embodiment extracts the region of interest in the RAW image by using the region of interest detected in the RGB 3 channel image. Because of this, it is possible for the image processing apparatus of the present embodiment to obtain image data from which the amount of information (for example, a tone level value for each pixel) indicating image quality characteristics of the RAW image is not lost while reducing the amount of data.

### Second Embodiment

The image processing apparatus 100 of the first embodiment receives an input of the RAW image 111 captured by a camera, not shown schematically, and outputs the RAW partial image 119, which is an image obtained by extracting only the region of interest in the captured RAW image 111. In a case where it is necessary to perform geometric transformation for the captured RAW image 111, the image processing apparatus 100 of the present embodiment outputs geometric transformation information 905 indicating the contents of the geometric transformation. Due to the geometric transformation information 905 output from the image processing apparatus 100, it is possible for an image processing server (not shown schematically) arranged in a subsequent stage of the image processing apparatus 100 to perform predetermined image processing by using the geometric transformation information 905. Details of the geometric transformation will be described later.

### (Generation Procedure Example of RAW Partial Image in Second Embodiment)

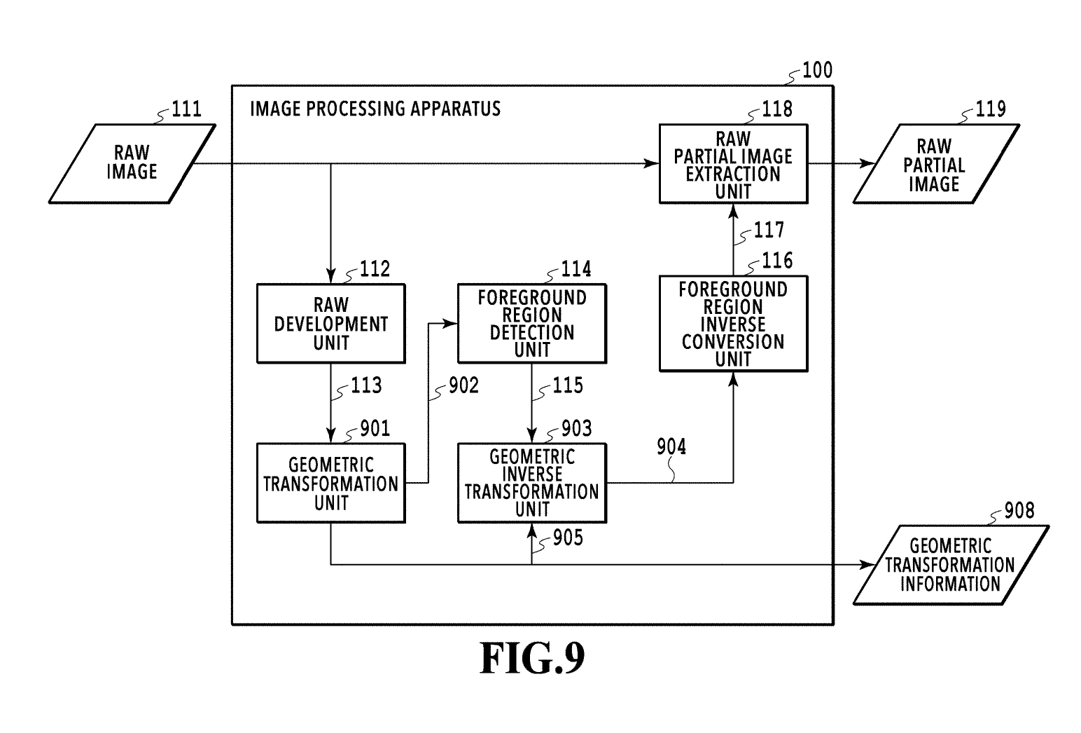

FIG. 9 is a block diagram showing a function configuration example of the image processing apparatus 100 in the present embodiment. FIG. 10 is a flowchart showing a generation procedure example of the RAW partial image 119 in the present embodiment. In the following, with reference to FIG. 9 and FIG. 10, a processing procedure of the image processing apparatus 100 in the present embodiment is explained. The configuration in common to that of the first embodiment is explained by attaching the same symbol.

At S301, the RAW image 111 is input.

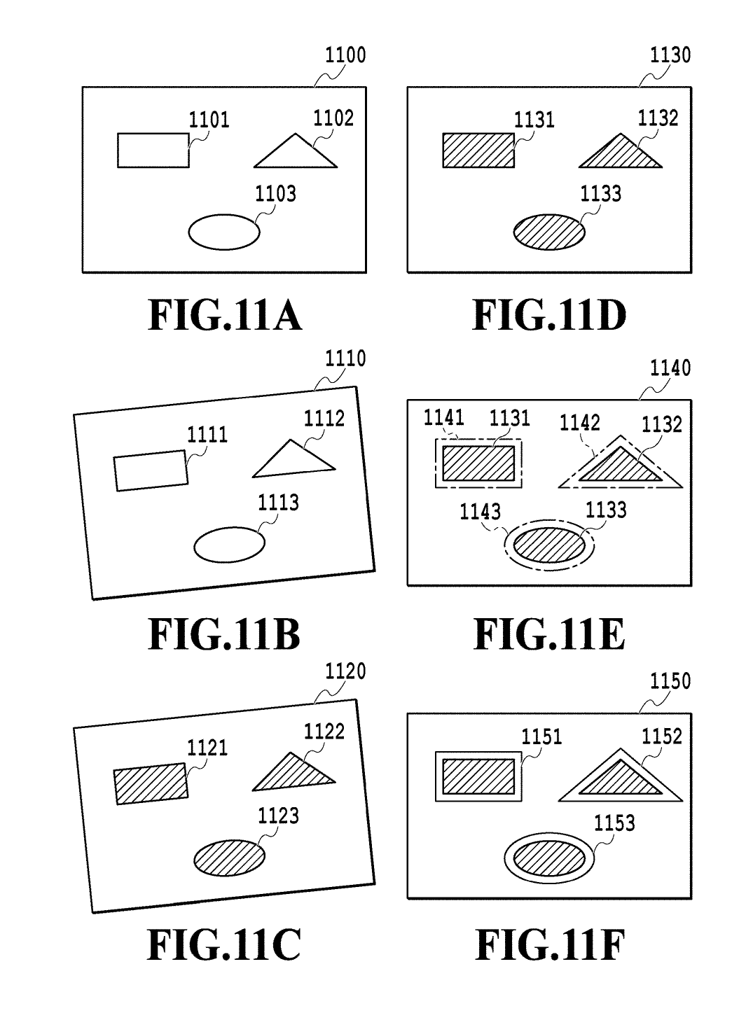

At S302, the RAW development unit 112 performs RAW development processing. The RGB image 113 is the results of the RAW development unit 112 performing RAW development processing for the RAW image 111. FIG. 11A is a diagram showing an example of an RGB image 1100 obtained by performing the RAW development processing for a RAW image. In the RGB image 1100 shown in FIG. 11A, foregrounds 1101 to 1103 are included as target portions of interest.

At S1001, a geometric transformation unit 901 receives an input of the RGB image 113 and performs geometric transformation for the image. The effect of the geometric transformation in the present embodiment is explained below. The image processing apparatus 100 in the present embodiment receives an input of a captured image of a camera (not shown schematically), but there is a case where the camera vibrates due to the influence of the environment in which the camera is installed and as a result, the image itself of the RAW image shifts in position for each frame. In such a case, it is possible to correct the shift in position by performing geometric transformation. Further, there is a case where geometric transformation is necessary in processing to detect a foreground. For example, in a case where foreground region detection processing by disparity between cameras is performed by using captured images captured by a plurality of cameras installed at different positions, it is possible to modify the captured image of each camera to a position at which disparity between cameras can be compared. In accordance with one of the above-described purposes, it is possible for the geometric transformation unit 901 to output an RGB geometrically transformed image 902 and the geometric transformation information 905, which are the geometric transformation results.

FIG. 11B is a diagram showing an example of an RGB geometrically transformed image 1110 in the present embodiment. In the example in FIG. 11B, the RGB geometrically transformed image 1110 obtained by performing geometric transformation, which is rotation processing, for the RGB image 1100 is shown. In response to the RGB image 1100 being geometrically transformed, the foregrounds 1101 to 1103 are geometrically transformed (subjected to rotation processing) into foregrounds 1111 to 1113, respectively. In the RGB geometrically transformed image 1110 in FIG. 11B, the foregrounds 1111 to 1113 thus geometrically transformed are included.

At S303, the foreground region detection unit 114 receives an input of the RGB geometrically transformed image 902 output from the geometric transformation unit 901 and detects the foreground region within the image and then generates the foreground region information 115. FIG. 11C is a diagram showing an example of a foreground region 1120 represented by the foreground region information output from the foreground region detection unit 114 in the present embodiment. In the foreground region 1120 shown in FIG. 11C, foreground regions 1121 to 1123 corresponding to the foregrounds 1111 to 1113 in the RGB geometrically transformed image 1110 are included.

At S1002, an inverse geometric transformation unit 903 generates inversely transformed foreground region information 904. The inverse geometric transformation unit 903 of the present embodiment performs geometric transformation, inverse to the geometric transformation performed by the geometric transformation unit 901, for the foreground region information 115 based on the geometric transformation information 905 generated at S1001 and the foreground region information generated at S303. This is performed in order to detect to which position the position of the foreground region found (S303) after the geometric transformation (S1001) corresponds in the RAW image 111, which is the original camera-captured image. FIG. 11D is a diagram showing an example of a foreground region 1130 represented by the inversely transformed foreground region information 904 output from the inverse geometric transformation unit 903. In the inversely transformed foreground region 1130 shown in FIG. 11D, inversely transformed foreground regions 1131 to 1133 corresponding to the foreground regions 1121 to 1123 in the foreground region 1120 are included. As shown in FIG. 11D, the inversely transformed foreground regions 1131 to 1133 are regions sectioned by coordinates, which are the coordinates of the foreground regions 1121 to 1123 returned to those before the geometric transformation.

At S304, as in the first embodiment, the foreground region inverse conversion unit 116 receives an input of the inversely transformed foreground region information 904 and calculates to which position of the original RAW image 111 the input foreground region corresponds. Then, the foreground region inverse conversion unit 116 generates the RAW partial image region information 117 based on the corresponding portion of the foreground region in the original RAW image 111. FIG. 11E is a diagram showing a region corresponding to the foreground region 1130 represented by the inversely transformed foreground region information 904 in an original RAW image 1140. In FIG. 11E, RAW partial image regions 1141 to 1143 corresponding to the inversely converted foreground regions 1131 to 1133 are included.

At S305, as in the first embodiment, the RAW partial image extraction unit 118 generates the RAW partial image 119 based on the RAW image 111 input to the image processing apparatus 100 and the RAW partial image region information 117 generated at S304. Next, at S306, the generated RAW partial image 119 is output. FIG. 11F is a diagram showing an example of RAW partial images 1151 to 1153 extracted from the RAW image 111.

As explained above, it is possible for the image processing apparatus of the present embodiment to output geometric transformation information indicating the contents of geometric transformation performed for a RAW image along with a RAW partial image. Because of this, the image processing apparatus of the present embodiment has a further effect that it is possible for the image processing server arranged in a subsequent stage of the image processing apparatus to easily perform image processing for a RAW image by using geometric transformation information. In the above described first and second embodiments, the example of a case is explained where the image that is input to the image processing apparatus 100 is the RAW image 111. However, it may also be possible to input an image, which is a RAW image for which some image processing has been performed, to the image processing apparatus 100.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

According to the present invention, an effect is obtained that it is possible to obtain an image from which information indicating image quality characteristics of a captured image is not lost while reducing the amount of data.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2017-123409 filed Jun. 23, 2017, which is hereby incorporated by reference wherein in its entirety.

What is claimed is:

1. An image processing apparatus comprising:
a format conversion unit configured to convert an image in a first format into an image in a second format whose amount of information indicating image quality characteristics is reduced compared to that of the image in the first format;
a detection unit configured to detect a partial region in the image in the second format;
an inverse conversion unit configured to inversely convert region information representing the detected partial region into region information corresponding to the first format; and
an extraction unit configured to extract a partial image in the first format by using the inversely converted region information.

2. The image processing apparatus according to claim 1, wherein
the region information is a mask image representing the detected partial region.

3. The image processing apparatus according to claim 1, wherein
the extraction unit extracts the partial image in the first format in units of sets, the set including kinds of pixel making up the image in the first format.

4. The image processing apparatus according to claim 1, wherein
the partial image in the first format is extended compared to the partial region in the image in the second format.

5. The image processing apparatus according to claim 1, wherein
the first format is an image format having 1 channel pixel information.

6. The image processing apparatus according to claim 5, wherein
the first format is a RAW image format.

7. The image processing apparatus according to claim 1, wherein
the second format is an image format having 3 channel pixel information.

8. The image processing apparatus according to claim 7, wherein
the second format is an image format having RGB 3 channel pixel information.

9. The image processing apparatus according to claim 1, further comprising:
a geometric transformation unit configured to perform geometric transformation of the image in the second format;
an inverse geometric transformation unit configured to perform inverse transformation of the geometric transformation for the detected partial region; and
an output unit configured to output geometric transformation information indicating contents of the geometric transformation, wherein
the inverse conversion unit inversely converts region information representing the partial region inversely transformed by the inverse geometric transformation unit into region information corresponding to the first format.

10. An image processing method comprising:
a format conversion step of converting an image in a first format into an image in a second format whose amount of information indicating image quality characteristics is reduced compared to that of the image in the first format;
a detection step of detecting a partial region in the image in the second format;
an inverse conversion step of inversely converting region information representing the detected partial region into region information corresponding to the first format; and
an extraction step of extracting a partial image in the first format by using the inversely converted region information.

11. A non-transitory computer readable storage medium storing a program for causing a computer to function as an image processing apparatus, wherein
the image processing apparatus comprises:
a format conversion unit configured to convert an image in a first format into an image in a second format whose amount of information indicating image quality characteristics is reduced compared to that of the image in the first format;
a detection unit configured to detect a partial region in the image in the second format;
an inverse conversion unit configured to inversely convert region information representing the detected partial region into region information corresponding to the first format; and
an extraction unit configured to extract a partial image in the first format by using the inversely converted region information.
